(19) United States
(12) Patent Application Publication
(10) Pub. No.: US 2020/0289888 A1
(43) Pub. Date: Sep. 17, 2020

(54) Motion-Based Interface System

(71) Applicant: Yoav Neuman, Justin, TX (US)

(72) Inventor: Yoav Neuman, Justin, TX (US)

(21) Appl. No.: 16/817,561

(22) Filed: Mar. 12, 2020

Related U.S. Application Data
(60) Provisional application No. 62/816,910, filed on Mar. 12, 2019.

(51) Int. Cl. A63B 24/00; A63B 22/06; G06F 3/01

(52) U.S. Cl. CPC A63B 24/0021; A63B 22/0664; A63B 2220/16; G06F 3/011; G06F 3/017

(57) ABSTRACT

A motion-based interface system having a sensor to register physical activity of a user via a movable mechanical member to perform human input events to a computer system through the legs or lower body of a person. The invention allows a person sitting to exercise and enter computer commands at the same time.

### BACKGROUND

### 1. Field of the Invention

The present invention relates generally to human-computer interfaces systems, and more specifically, to a motion-based interface system that allows for the legs and feet of a user to provide motion to create input commands.

### 2. Description of Related Art

Systems and methods for human-computer interfaces are well known in the art. Many devices exist that translate the direct or indirect motion of a person into commands that are understood by a computer, such as a keyboard, touch screen, mouse, touchpads, and the like. For example, a keyboard has many buttons or keys that when pressed communicate a character to a computer than is then interpreted and action taken.

One of the problems commonly associated with common human-computer interface systems is their limited use. With advances in computers and the increased amount of work that is done on a computer, the user is constrained to be sedentary for long hours during the day. Health care professionals have determined that his behavior is detrimental to the health of the human user. Particularly, as they sit, the inactivity while working at a computer for long hours with limited physical activity.

Although great strides have been made in the area of human-computer interface systems and methods of use, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 depicts a side view of a motion-based interface system in accordance with a preferred embodiment of the present application;

FIG. 2 depicts a side view of an alternate embodiment of a motion-based interface system;

FIG. 3 depicts a side view of an alternate embodiment of a motion-based interface system;

FIG. 4 depicts a front view of a workstation system enabling a motion-based interface system;

FIG. 5 through 10 depict side views of various movements that are recognized as input commands in a motion-based interface system;

FIG. 11 depicts an alternative embodiment of the sensor of a motion-based interface system;

FIGS. 12 and 13 depict a method of controlling the module of a motion-based interface system;

FIG. 14 depicts a perspective view of an alternative embodiment of a motion-based interface system;

FIG. 15 is a diagram of a state machine in operation within a motion-based interface system; and

FIG. 16 is a flowchart of a method to method to promote physical activity.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods for motion-based interface systems. Specifically, the present invention is directed to a system and method to allow a user to operate a computer system via non-strenuous physical activity. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

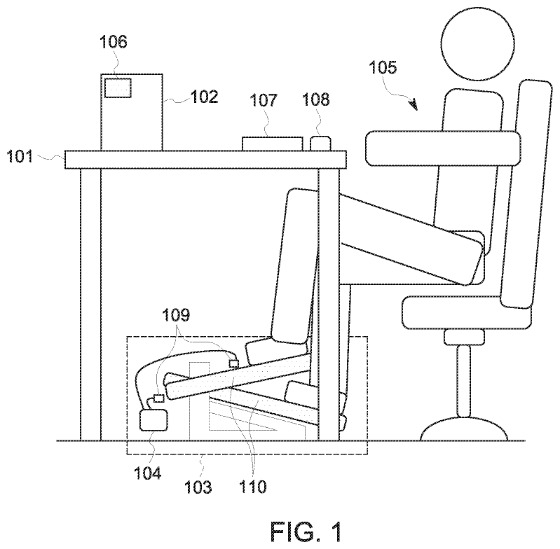

Referring now to the drawings wherein like reference characters identify corresponding or similar elements throughout the several views, FIG. 1 depicts a side view of a motion-based interface system in accordance with a preferred embodiment of the present application. It will be appreciated that the present invention overcomes one or more of the above-listed problems commonly associated with the conventional human-computer interface systems.

In the contemplated embodiment, system 101 includes an electronic device 102 housing a software module 106, a workstation desk 101 configured to support the electronic device 102, a keyboard 107, and a mouse 108. wherein the keyboard and mouse are connected, wired or wirelessly, to the electronic device 102, and a user 105. The system is further shown with an exercise apparatus 103 that includes: movable mechanical members 110, one or more motion sensors 109, and an electronic module 104 in communication with the sensors 109. The electronic module 104 is configured to receive signals detected from the sensors, process the signals, and convert the signals into electronic signals used to communicate with the electronic device to cause action within the electronic device 102 and software module 106 being used by the user 105. The electronic module 104 may be in wired or wireless communication with the sensors 109 and electronic device 102. The sensors 109 are configured to sense time-varying aspects of the mechanical members 110 including but limited to the position, displacement, velocity or acceleration of each of the movable mechanical members 110.

The exercise apparatus 103 is positioned such that the user 105 may perform exercise movements to assist in the operation of the computer. In the motion-based interface system shown in FIG. 1, the movable mechanical members provide resistance to the physical motion of the user 105. In one embodiment, the physical motion is achieved by the user independently pressuring the movable mechanical members 110 with his or her feet, wherein the user 105 remains seated in a chair with the exercise apparatus 103 positioned in front of the user on the ground below the workstation desk 101. In an alternate embodiment, the user 105 may mount the exercise apparatus 103 directly, using the exercise apparatus as a support without the use of a chair. The exercise apparatus 103 may be configured as a compact elliptical trainer wherein the movable mechanical members are configured as rotationally connected foot pedals. Alternatively, the exercise apparatus 103 may be configured as a compact stair stepper. In alternate embodiments, the exercise apparatus 103 may be configured as a strider, a stationary bike, climber or other standard exercise machine having movable mechanical members configured to be actuated by a user's limbs.

It is anticipated that the electronic device may be configured as any electronic device having a processor and memory device configured to allow for the storage and use of a software program or operating system requiring human input for functionality and use. The electronic device may be a desktop computer and monitor, laptop, tablet, mobile device, or another electronic device.

It is anticipated that the workstation desk 101 may be configured as any stand facilitating ease of use and physical support of the electronic device 102 for a user. In FIG. 1, the workstation desk 101 is depicted as a seated workstation; however, the workstation desk 101 may be configured such that a top of the workstation desk 101 is positioned such that a user may be standing while operating the electronic device 102 via the exercise apparatus 103. For stand-up exercise and electronic device operation, the exercise apparatus 103 may be positioned near the workstation desk 101.

It is anticipated that the keyboard 107 and mouse 108 may be alternatively configured as a touch-pad with or without a touch stylus or other input device.

It is contemplated that the sensors 109 provided data of the movements to the electronic module 104 and therein operate a state machine or method of monitoring the movements and translating them into signals. It will be understood that a state machine evaluates the current state of the system and compares it with predetermined sequences of actions to create the signals as opposed to a direct single for each motion. For example, when a motion is detected the system is triggered and waits for a subsequent motion and creates a signal based on the second motion. In this way pauses, holds and other such non-motions are also captured and utilized by the system.

Further it is contemplated that the electronic module 104 could prepare signals for the electronic device 102 to interpret or that it could create signals that duplicate the input from a keyboard or mouse. It will be understood that this system could communicate with any operating system on electronic device 102 such as Windows or Macintosh OS.

In one embodiment, the electronic module 104 continuously transmits data received from the sensors 109 to the software module 106 housed on the electronic device 102. The software module 106 is configured to analyze data received from the electronic module 104 and determine an amount of exercise achieved by the user as interpreted from the data received. The software module 106 stores pre-determined or user-specified thresholds of physical activity. The software module 106 compares the amount of exercise achieved with the pre-determined activity level thresholds. When the user's physical activity registers above a pre-determined threshold, the software module 106 is configured to send a command to the operating system of the electronic device to simulate an event traditionally initiated from a connected human input device, wherein the event may be defined as a mouse button click, mouse button double click, mouse movement, mouse scrolling, keyboard key click, a touchpad event, a joystick event or other human input event traditionally actuated via a human input device for a computer or electronic device.

In an alternate embodiment, the electrical module 104 is configured to carry out data analysis internally and send messages to the software module 106 to indicate when the user's physical activity or exercise exceeds a stored threshold level. The software module 106, upon receipt of notification that a stored threshold level has been exceeded, is configured to send a simulated human input device (HID) event command to the electronic device 102.

In a further embodiment, the electrical module 104 is configured to be detected by the computer or electronic device 102 as a standard HID such as a mouse or keyboard, wherein when the electrical module 104 detects that a user's exercise has exceeded a certain threshold, it is configured to send a command to the computer simulating an event on the specified HID.

As an example, wherein the movable mechanical members are configured as an under-desk compact elliptical trainer having two optical sensors for detecting whenever the right foot-pedal is at a top-most or bottom-most position. Two successive detections from each of the two sensors indicate that the user has completed one half of a predetermined exercise cycle. A full exercise cycle may be defined as when the right foot actuates through the topmost position to the bottom-most position and returns to the top-most position. When the user has completed a full exercise cycle, the electrical module 104 creates and sends a notification to the software module 106 which may be configured to command the operating system to receive the notification as a simulated left mouse button click. Alternatively, the software may be configured to initiate said command after detecting a known amount of half-cycle steps.

In another embodiment, the under-desk compact elliptical trainer may utilize an encoder to sense an angle of a user's foot pedal relative to the floor. The angle may be correlated to a proportioned angle created by the axes of a connected mouse, wherein the angle of the user's foot pedal, as actuated by the user's foot, may control one of the axes of the connected mouse. For example, the raising or lowering of the foot pedal of the elliptical trainer may control an indicating point on the x-axis of the mouse's range of motion on a 2D visual display of an electronic device. The y-axis may then be controlled by the mouse as usual.

Software module 106 may further be set to disable input device functionality so that whenever a user requires the action normally carried out by the HID, the user 105 must carry out an exercise activity. In the previous example, software module 106 may be set to disable the LMC (left mouse button click) coming from the standard mouse and, whenever the user needs to perform a left mouse button click (in order to activate software features on applications running on the electronic device 102, such as hitting a hyperlink on a browser) then he or she must carry out a one half cycle move on the elliptical trainer. In another embodiment, the disabling of standard input device functionality is achieved by providing a dedicated input device. By way of example, the present invention may be shipped with a special mouse that has a hardware switch that enables and disables its left button. The user may then use said switch to disable or enable the left mouse button. This would replace the software-configured input device functionality control.

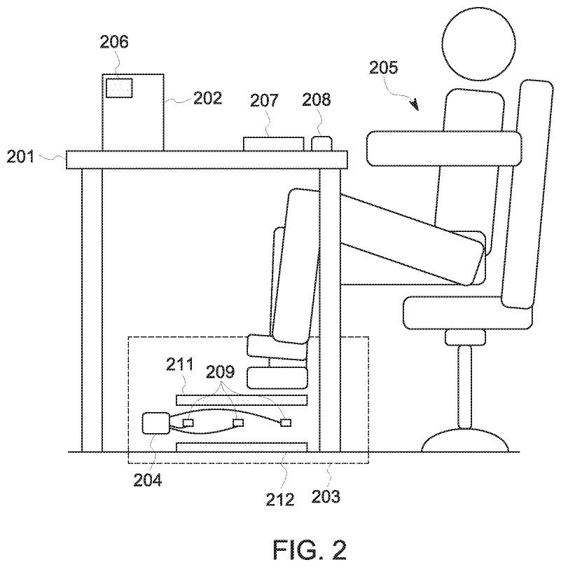

Referring now to FIG. 2, a system 201 is shown having a desk 201, an electronic device 102 housing a software module 206, a plurality of human input devise 207, 208, a user 205, and an exercise apparatus 203. The exercise apparatus 203 includes movable mechanical member 211, at least one sensor 209, an electrical module 204, and a floor member 212. In an alternate embodiment, movable mechanical member 211 and floor member 212 may be configured as one integrated unit. The at least one sensor 209 may be in communication with the electronic module 204, wherein the at least one sensor 209 is configured to determine the position of the feet of the user 205, specifically when both of the feet of the user 205 are lifted off the ground. The position of the feet of the user 205 may be determined in a variety of methods.

In one embodiment, the movable mechanical member 211 and floor member 212 include a set of conductors positioned such that when the members 211 and 212 constitute a top surface and a bottom surface to make contact, an electrical circuit is closed and allows the electrical module 204 to be in communication with the at least one sensor 209 and electronic device 202. A spring may be used to separate the members 211 and 212, such that when a user does not actuate the movable mechanical member 211 to make contact with the floor member 212 the circuit remains open. A closed-circuit indicates the user is pressing down on member 211 onto the floor member 212. Other embodiments may include: Sensor 109 include one or more pressure or force sensors that sense the pressure or force between said top and bottom surfaces. Pressure/force exceeding a certain threshold indicates a user foot resting on pad; A spring is used to separate said top and bottom surfaces so that when user's feet are not rested on said pad, a mechanical feature is not interfering in the path of an optical sensor when user's feet are rested on said pad the surfaces are brought nearer to each other and a feature blocks said optical path and is detected by said sensor; The top and bottom surfaces are conductive and a springy dielectric or a dielectric together with a springy material are placed between them so that applied pressure reduces their distance. A circuit connected to the top and bottom conductors measures the capacitance and detects foot down/up status; The top surface is conductive and connected to a capacitive proximity sensor.

It is anticipated that the movable mechanical member 211 and floor member 212, constituting a footpad, may be configured to allow a user to stand on the footpad.

In addition to driving sensors 209, electronic module 204 may include means to communicate with a computer through a wired or wireless channel. In one embodiment of this system, electrical module 204 continuously transmits data from sensors 209 to software module 206 running on computer 202. Said software module analyzes the data to detect exercise activity—when one or both feet are lifted off foot pad 203 for a certain amount of time. Every time software module 206 detects said exercise activity, it sends a command to the operating system to simulate an event initiated from a connected HID (human input device). Said event including but not limited to a mouse button click, a mouse button double-click, a mouse movement, a mouse scroll-wheel position change, a keyboard key click, a touchpad event and a joystick event. In another embodiment of this system, electrical module 204 carries out said data analysis internally and sends messages to software module 206 to indicate said exercise activity has taken place. Software module 2066 then sends the ‘simulate HID event’ command to the computer or electronic device 202 as described above. In another embodiment of this system, electrical module 204 presents itself to the electronic device 202 as one or a combination of standardized HIDs (mouse, keyboard, etc.). Every time module 204 detects said exercise activity, it sends a command to the electronic device 202 simulating an event on said HID (clicking of a mouse button, the clicking of a keyboard button, etc.). Software module 206 can further be set to disable input device functionality so that whenever users need it they must carry out said exercise activity. In the previous example, software module 206 would be set to disable the LMC (left mouse button click) coming from the standard mouse and, whenever the user needs it (in order to activate software features on applications running on the PC, such as hitting a hyperlink on a browser) then he/she must carry out said exercise activity. In another embodiment, the disabling of standard input device functionality is achieved by providing a dedicated input device. By way of example, the present system can be shipped with a special mouse that has a hardware switch that enables/disables its left button. The user can then use said switch to disable/enable the left mouse button. This would replace the software-configured input device functionality control.

As is common with computers and other electronic devices errors accumulate as they operate. These have various sources such as a gyro/accelerometer in the present invention. As data is collected from these sensors errors also accumulate. It is contemplated that these errors must be accounted for and by tools within the device. In the present embodiment, it is contemplated that the gyro/accelerometer is tracked to determine when the motion is near zero. Only the accelerometer is used to calculate the angle of the leg when the leg begins to move the gyro activated and added to the leg position. As this motion resets frequently, the accumulated errors are also removed and reset frequently.

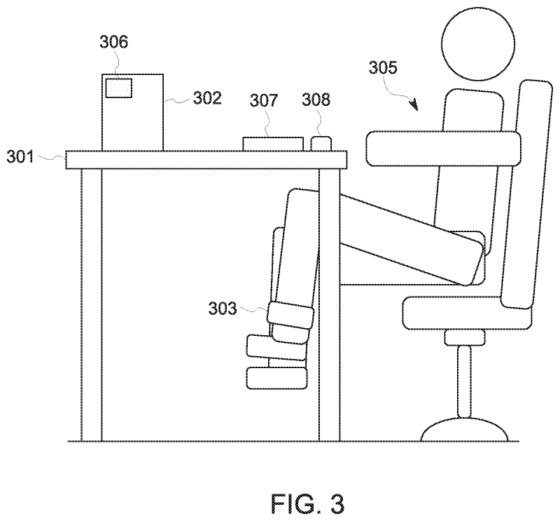

Referring to FIG. 3, the present invention is shown in a system that includes a desk 301, a computer device 302 housing a software module 306, a plurality of human input devices 307, 308, and a user 305 wearing a sensor device 303. In this system, an exercise activity is defined as at least one motion of at least one limb for a pre-determined level of a parameter such as time, distance, acceleration rate, or magnitude and direction of velocity. Sensor device 303 is configured to detect an exercise activity. Many methods exist for wearable devices to detect said exercise activity including but not limited to using an accelerometer and a gyroscope. Two of said wearable devices may be used—one for each leg. Alternatively, a single leg can be monitored at a time, later to be swapped with the other. Said wearable device communicating with a computer through wireless or wired means. Optionally, the system may include ankle weights (or other weights) that are attached to the leg in order to increase the resistance of the exercise.

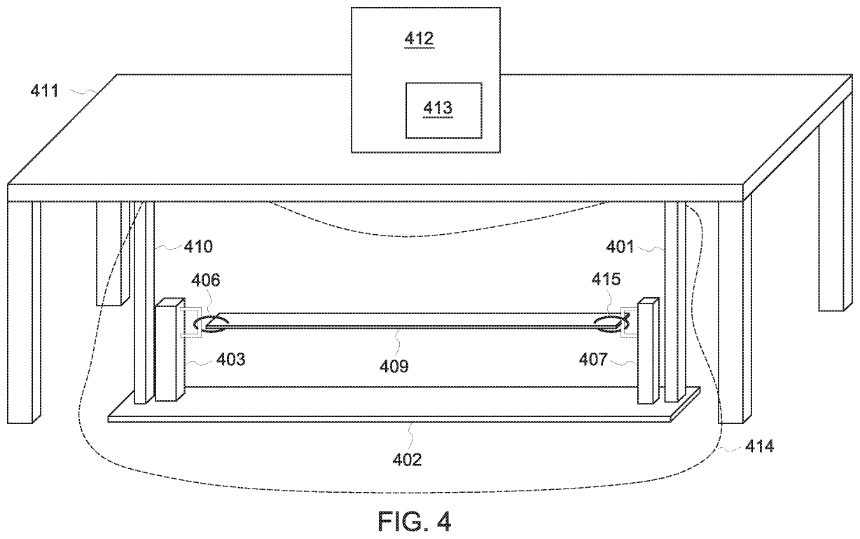

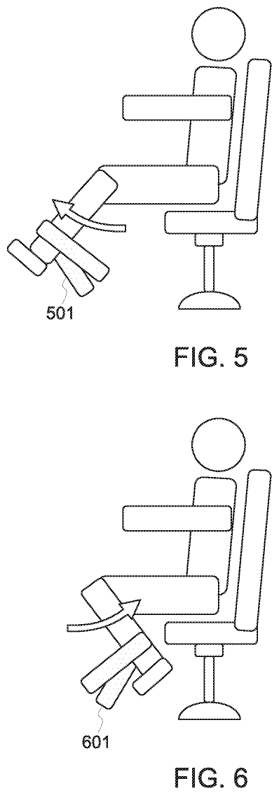

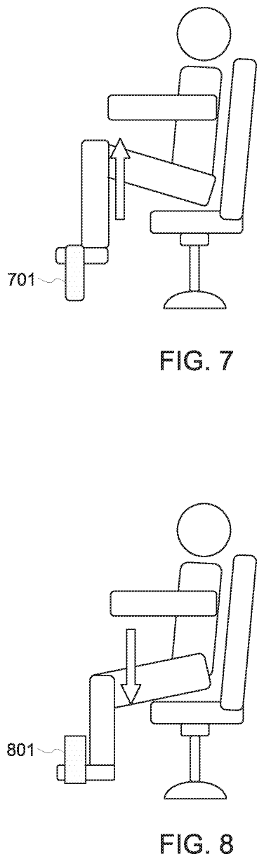

Referring now to FIG. 4, a system of the present invention is shown. In this embodiment, a user sitting on a chair (not illustrated) operates computer 412 operably associated with table 411 and running dedicated software module 413. Exercise apparatus 414 is situated under table 411 allowing said user to exercise while operating said computer. Exercise apparatus 414 includes springy member 409 stretched between mechanical members 403 and 407 such that it is substantially horizontal and elevated off the ground to accommodate a user's feet. Mechanical members 403 and 407 are rigidly attached to a thin, substantially horizontal member 402. When not performing exercise activity, users will typically rest their feet on member 402. Physical exercise is achieved with the legs stretching and releasing said springy member in one of four rough directions illustrated in FIGS. 5 through 8. Said springy members are depicted 501-801 and the arrows in these figures illustrate the approximate directions. Springy member 409 is attached to the rest of exercise apparatus 414 through detachable members 406 and 415. This allows users a low-cost solution supporting multiple resistances. Users may select different exercise resistance by replacing springy member 409 with another one, differing in resistance. Also, said detaching ability allows for replacing a malfunctioning springy member on its own rather than the full system (springy members may have a limited durability). Although FIG. 4 illustrates exercise apparatus 414 under a desk, it may also be used when a user is standing up.

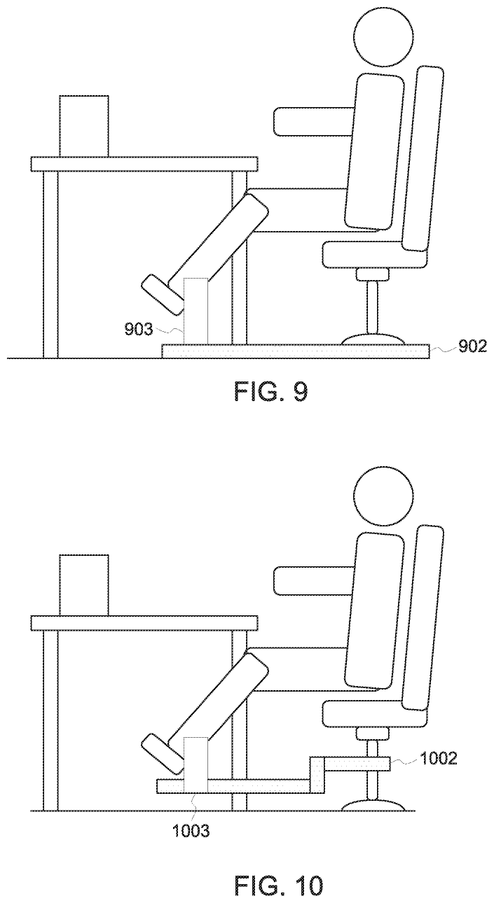

Mechanical members 401 and 410 may be pressed between table 411 top and rigid member 402 such that table 411's weight causes it to be strapped down. This is done at the installation of the system. Since both ends of springy member 409 may be rigidly attached to member 402 (through members 404 and 407), any vertical force applied to member 409 will be countered by the table's weight. Alternatively, members 401 and 410 may be pressed directly between table 411 top and members 404 and 407 respectively. Mechanical members 401 and 410 have a configurable height and therefore can support a wide range of table heights (many ways to implement are well known in the art, one of them based on the use of telescopic poles). To substantially prevent motion in the horizontal direction, member 402 may be made out of high friction material. Alternatively, a strip of high-friction material may be attached to it. FIG. 9 shows a side view of another system to said strap-down configuration. In this embodiment, a flat rigid member is configured longer such that the user's chair is to be placed on top of it. The user's weight combined with the chair's weight and any vertical force applied by the user on said springy element is applied back to said exercise apparatus 414, preventing it from moving up. Member 902 can be made from a high friction material or a high friction material can be attached to it. This will substantially prevent or reduce horizontal motion. FIG. 10 shows a side view of still another solution to said strap-down problem. In this embodiment of the system, member 1002 is assembled by the user onto their desk chair. Most desk chairs use a vertical round pole to connect the base to the chair seat. Member 1002 may have a mechanical interface that, during installation, connects it to said round pole. In this solution, member 1002 doesn't necessarily need to rest on the floor since it is supported by the chair. Further, in this solution, said exercise apparatus moves with said chair. When the system is used while the user is standing up, one foot must always rest on horizontal member 1002.

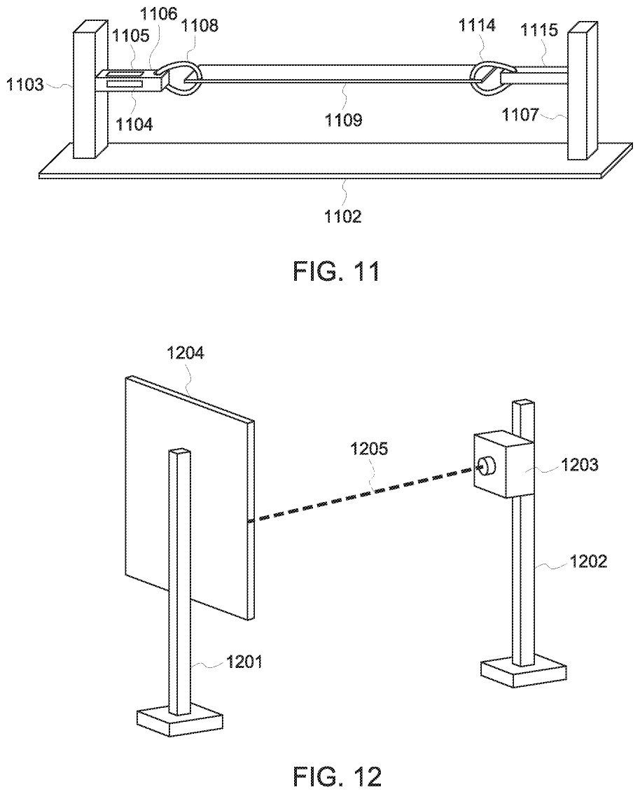

Referring to FIG. 11, the present invention is shown as an alternate embodiment for a mechanism for sensing a user's physical activity to be registered by the electronic module. Items 1102, 1103, 1007 & 1109 in this figure are alternate configurations of the corresponding items in FIG. 4 respectively. One side of springy member 1109 connects to substantially horizontal, semi-rigid member 1106. Sensors 1104 and 1105 are strain gauges that sense contraction and expansion of semi-rigid element 1106. Electronic module 1104 connects to said sensors and extracts from them force, position and direction information of exercise carried out by the user. From this information (or the above described software module) it is discerned whenever the exercise exceeds a certain threshold.

In another embodiment of said sensing solution, said force sensor is placed between elements 1103 and 1102 and is used to extract information about the force exerted by the user. In another embodiment, at least one end of said springy member is attached to a spherical element that is held by a socket such that it is free to rotate about its center up to some angle. In one implementation of this embodiment, a magnet is mechanically attached to the spherical member and a magnetic flux sensor that is fixed in space relative to the sphere center measures magnetic flux that changes as a function of the sphere's orientation. A ‘base’ flux reading indicates the sphere's orientation without the user applying force on the springy member. By comparing the flux sensor's current reading with the base reading, said electric module can extract information about the direction, force and position of the exercise activity. In another implementation of this embodiment, said spherical member's orientation is sensed by an optical sensor detecting features on the spherical member. In another embodiment said springy member is mechanically coupled to a mechanical member whose position is sensed by an optical sensor.

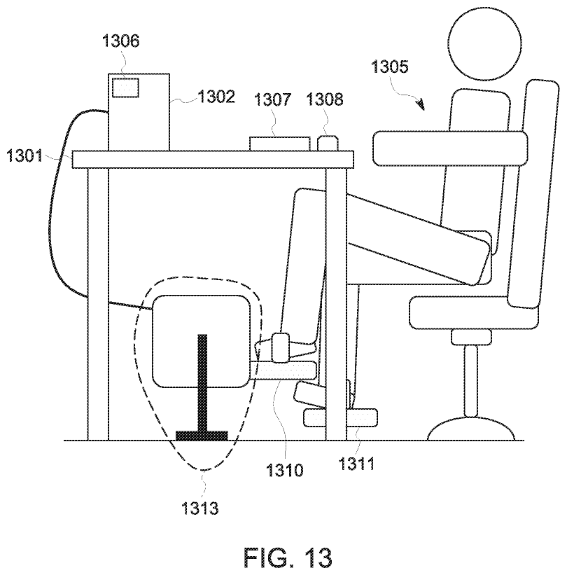

Referring now to FIGS. 12 and 13, a user 1305 may operate a computer or electronic device 1302 via a weight sandal 1310 which includes one or more weights for each leg that provide resistance when the user lifts his or her leg. Module 1313 is configured to detect exercise activity performed by the user, i.e. when one or both feet reach a pre-determined position. Module 1313 is depicted in FIG. 12 and includes a member 1203 having at least one presence detection sensors that may sense or detect a foot crossing a pre-designated boundary 1205. Many low-cost solutions can be used for this, including ultrasonic range finders, photo-interrupter, cameras, IR sensors, etc. By way of example, a photo-interrupter system may send a beam of light in the direction of line 1205 to a mirror 1204 that is positioned in a plane substantially orthogonally to line 1405. Said photo-interrupter sensing a foot crossing event by detecting a change in the intensity of reflected light. In another example, an ultrasonic range finder is used and member 1204 is a flat member that, as before, is positioned in a plane substantially orthogonally to line 1205. The sensor returns the distance of the nearest object. Upon initialization, the sensor finds the average distance to member 1204. A foot crossing is detected when that distance changes by a significant amount. Member 1204 is not mandatory but helps in reducing error in changing environments. By moving stands 1201 and 1202, virtual line 1205 can be moved in space in order to allow users to configure the extent of motion. Further, sensor 1203 and reflector 1204 can be moved up or down to achieve the same purpose. As in previously described solutions, sensor 1203 is connected to a communication module (not illustrated) that communicates with a computer. Software operating on the computer controls the computer's behavior based on activity information received, as described in previous solutions.

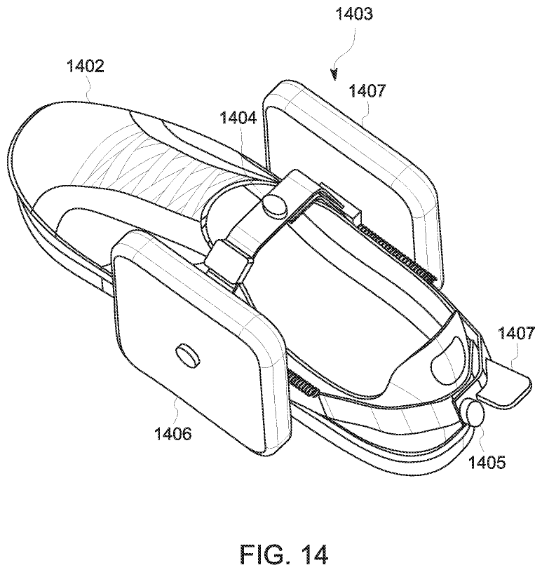

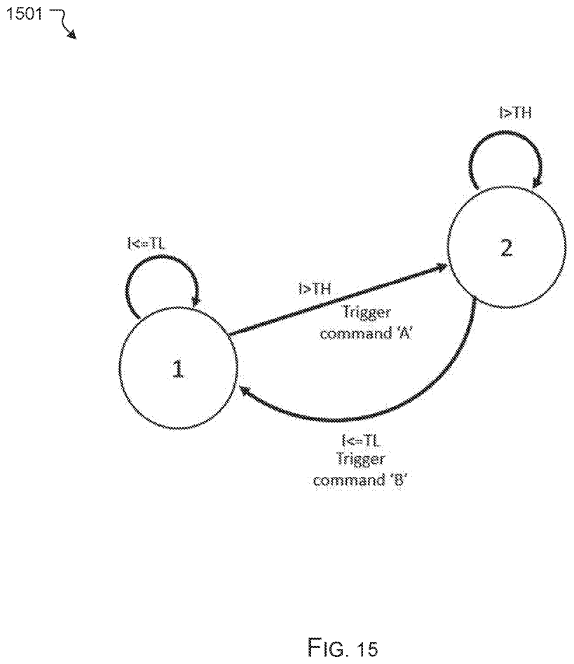

FIG. 14 illustrates one implementation of a weight sandal 1310. The weight sandal is shown having a top strap 1404 and a back strap 1407 that are configurable in length to adjust to multiple shoe sizes. In order to use the sandal 1310, one of the user's feet lowers the back strap while the other foot is pushed in. When the back strap is then let go a spring 1405 brings it back to place to lock the shoe 1402 in. Weights 1406 and 1407 can be added to the sandal as desired.

In a further embodiment, the system of FIG. 13 may include a wearable device configured as a weight sandal 1310. It is anticipated that the motion-sensing capabilities of the system may be carried out via a singular sensor located within the weight sandal 1310 or another wearable device, a singular sensor located outside the wearable device but within the system, or a plurality of sensors in wired or wireless communication located within the wearable device and elsewhere in the system.

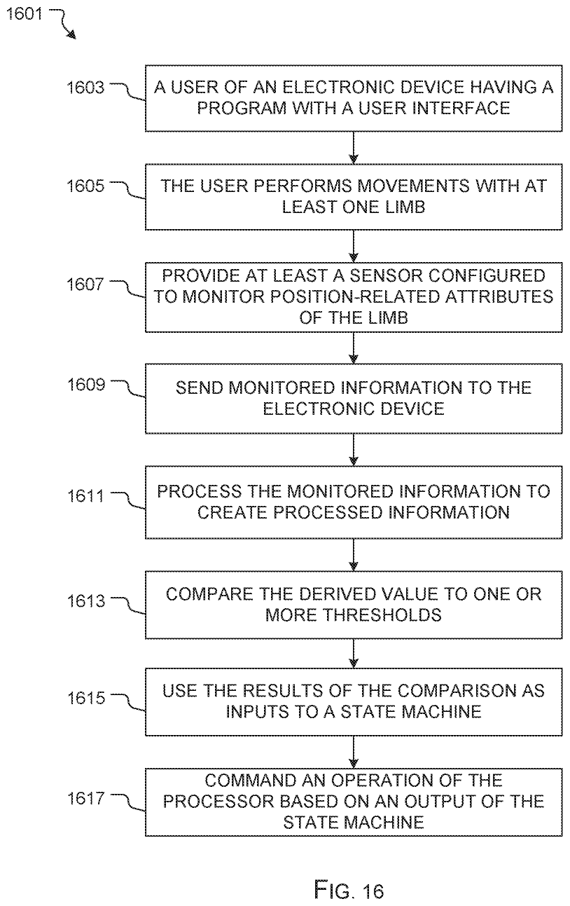

Referring now to FIG. 15 a state machine 1501 is depicted in use within the system. It is contemplated that there could be many events or actions that could be monitored by the sensors. TH is a high threshold, and TL is a low threshold. In first example command ‘A’ is a press the left mouse button and command ‘B’ is the release of the left mouse button In another example command ‘A’ is a press and release the left mouse button and command ‘B’ is null.

When the system begins it is contemplated that the user could select from a predetermined set of motions for what they want the sensors to track. It is further contemplated that the user could alter the motions at any point during the use of the system.

It will be understood that the sensor could be attached to the user or stationary with respect to the user. The concept that has been described is that the sensor is configured to capture the motion of the user.

The present invention is also directed to a method to utilize and correlate position data of a user to simulate a human input event and cause action within a processor of an electronic device, the method includes a user of an electronic device having a processor and a program with a user interface 1603, the user performing movements with at least one limb 1605, providing at least one sensor configured to monitor position-related attributes of the at least one limb 1607, sending monitored information to the electronic device 1609, processing monitored information to create processed information 1611, comparing the derived value to one or more thresholds 1613, using the results of the comparison as inputs to a state machine 1615 and commanding an operation of the processor based on an output of the state machine 1617.

It is anticipated that the position data or pre-determined threshold of physical activity may be correlated to any human input event including but not limited to: a left or right mouse click, a double mouse click, movement of a scrolling device, a touchpad event or other— wherein the simulated human input event causes action within a processor of an electronic device.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A motion-based interface system comprising:
an electronic device configured to store a software module; an exercise apparatus comprising:
at least one movable member configured to be actuated via the user; and
at least one sensor to detect position data of the movable mechanical member;
wherein the software module is configured to receive position data from the sensor and upon detecting a pre-determined motion, commands an operation of the processor of the electronic device.

2. The system of claim 1, wherein the detecting of a pre-determined motion includes waiting for position data to exceed a high threshold after being lower than a low threshold.

3. The system of claim 1, wherein the data from the sensors is monitored in a state machine to create the commands sent to a computer.

4. The system of claim 1, wherein the latency of the detection of the motion by the sensor is below 1000 milliseconds.

5. The system of claim 1, wherein the exercise apparatus is one of the following an elliptical trainer, an exercise bike, a stair stepper, free-standing pedals, a spring band stretched between a rigid support allowing a user to press against the spring band or an ankle weight or weighted sandal.

6. The system of system of claim 1, wherein the movable member is configured as a wearable device having one or more of the following: an accelerometer, gyroscope, or magnetic sensor.

7. The system of claim 1, wherein the sensor is configured to measure one or more of linear acceleration, velocity, angle, angular velocity, distance, displacement or magnetic flux.

8. The system of claim 1, wherein the system reduces cumulative error such as by zeroing out values when near-zero velocity states are detected.

9. A motion-based interface system comprising:
an electronic device configured to store a software module; and
an exercise apparatus comprising:
at least one weight configured to be actuated via the user; at least one sensor to detect position data of the weight;
wherein the software module is configured to receive position data from the sensor and upon detecting a pre-determined motion, commands an operation of the processor of the electronic device; and
wherein when a pre-determined motion is detected the sensor monitors the user for a second motion which alters the operation commanded of the processor of the electronic device.

10. The system of claim 9, wherein the detecting of a pre-determined motion includes waiting for position data to exceed a high threshold after being lower than a low threshold.

11. The system of claim 9, wherein the data from the sensors is monitored in a state machine to create the commands sent to a computer.

12. The system of claim 9, wherein the latency of the detection of the motion by the sensor is below 1000 milliseconds.

13. The system of claim 9, wherein the exercise apparatus is one of the following an elliptical trainer, an exercise bike, a stair stepper, free-standing pedals, a spring band stretched between a rigid support allowing a user to press against the spring band or an ankle weight or weighted sandal.

14. The system of system of claim 9, wherein the movable member is configured as a wearable device having one or more of the following: an accelerometer, gyroscope, or magnetic sensor.

15. The system of claim 9, wherein the sensor is configured to measure one or more of linear acceleration, velocity, angle, angular velocity, distance, displacement or magnetic flux.

16. The system of claim 9, wherein the system reduces cumulative error such as by zeroing out values when near-zero velocity states are detected.

17. A method to promote physical activity comprising:
a user of an electronic device having a processor and a program with a user interface;
the user performing movements with at least one limb;
providing at least one sensor configured to monitor position-related attributes of the at least one limb;
sending monitored information to the electronic device;
processing monitored information to create processed information;
comparing processed information to one or more thresholds;
using the result of comparing as an input to a state machine; and
commanding an operation of the processor based on an output of the state machine.

18. The method of claim 17 wherein the state machine is removed and the results of comparing are used against a set of pre-determined motions.

19. The method of claim 17, wherein the detecting of a pre-determined motion includes waiting for position data to exceed a high threshold after being lower than a low threshold.

20. The method of claim 17, wherein the latency of the detection of the motion by the sensor is below 1000 milliseconds.

21. The method of claim 17, wherein the movements occur in one of the following an elliptical trainer, an exercise bike, a stair stepper, free-standing pedals, a spring band stretched between a rigid support allowing a user to press against the spring band or an ankle weight or weighted sandal.

22. The method of system of claim 17, wherein limb is a leg.

23. The method of claim 17, wherein the sensor is configured to measure one or more of linear acceleration, velocity, angle, angular velocity, distance, displacement or magnetic flux.

24. The method of claim 17, wherein the system reduces cumulative error such as by zeroing out values when near-zero velocity states are detected.
